(19) United States
(12) Patent Application Publication
(10) Pub. No.: US 2008/0309738 A1
(43) Pub. Date: Dec. 18, 2008

(54) External ink supply and balancing system for inkjet printer

(76) Inventor: Yi-Tsung YAN, Taipei (TW)

Correspondence Address: TROXELL LAW OFFICE PLLC, 5205 Leesburg Pike, Suite 1404, Falls Church, VA, 22041, US

(21) Appl. No.: 12/139,198

(22) Filed: Jun. 13, 2008

(30) Foreign Application Priority Data
Jun. 14, 2007 (TW) 096209783

(51) Int. Cl. B41J 2/175

(52) U.S. Cl. 347/85

(57) ABSTRACT

An external ink supply and balancing system for inkjet printer, which mainly comprises a reflow system of each ink container of an inkjet printer be blocked and to have each ink container be connected to a respective external ink bottle through a respective L-shaped connector and flexible ink supply tube and also to be an air bag connected to an air discharge connector at each ink bottle through a flexible tube for collecting exhaust air so that when the inkjet printer runs an ink circulation flow, the ink bottles supply inks to the respective ink containers and guide exhaust air out of the ink containers to the air bag.

### BACKGROUND OF THE INVENTION

1. Field of the Invention

This invention relates to an ink supply system for inkjet printer, and particularly to an external ink supply and balancing system for inkjet printer.

2. Description of the Prior Art

In the conventional inkjet print commonly have an Active Air Management, the Active air management has a pump set between the printing-fluid delivery system and the ink containers and a plurality of flexible tubes respectively connected between the ink containers and respective vent chambers. During the first use of a new inkjet printer of the aforesaid design to run an ink circulation flow, the pump pumps the ink from each ink container into the ink chamber of the printing-fluid delivery system, till that the corresponding ink chamber and printer head have been fully filled with the respective ink. Following the operation of the inkjet printer and consumption of the ink of each ink container, air enters each respective ink chamber to balance the pressure. When the ink in one ink chamber of the printing-fluid delivery system dropped below a predetermined low level, a demand signal is produced, causing the pump to start the ink supply flow again. At this time, the pump pumps air out of the printer head at first, and then pumps the ink from the respective ink container into the respective ink chamber of the printing-fluid delivery system. This circulation is repeated two or three times till that the respective ink chamber of the printing-fluid delivery system is fully filled up with the respective ink for printing. Before a new supply of the ink from one ink container to the printing-fluid delivery system, the exhaust air goes from the printer head through the ink in the respective container toward the respect vent chamber. When a flow of exhaust air goes through the ink in one ink container, the ink in the respective ink container is caused to produce ink bubbles that move with the flow of exhaust air to the respective vent chamber. When ink bubbles entered the vent chamber, they pop within a short period and convert into water-like ink, and water-like ink thus produced immediately flows back from the vent chamber to the respective ink container for further supply to the printing-fluid delivery system for printing.

The capacity of the ink containers of an inkjet printer of the aforesaid design is limited. When heavy printing is required, the cost of the original ink container system is high.

In a conventional available supplementary ink supply systems for use with an inkjet printer to lower the printing cost. According to one supplementary ink supply system, a connector is attached to each ink container, and then a flexible tube is used to connect respective external ink reservoirs to the connectors at the ink containers. During an ink supply flow, the ink in each external ink reservoir has a pressure that prohibits exhaust of air out of the inkjet printer, and therefore exhaust air is kept in the vent chambers of the inkjet printer, limiting the ink supply capacity of the external ink reservoirs.

In another supplementary ink supply system, substitute ink containers are mounted in the holder of the inkjet printer. Each substitute ink container has a connector connected to the pump of the inkjet printer and an external part connected to an external ink bottle through a respective flexible tube. According to this arrangement, the external ink bottles are spaced from the pump at a distance. When the pump is started to pump one ink into the printing-fluid delivery system after exhaust of air from the printer head, residual air in each flexible tube will be forced into the printing-fluid delivery system during forward flowing of the respective ink from the respective ink bottle through the respective substitute ink container toward the printing-fluid delivery system, resulting in formation of bubbles in the printer-head. These bubbles will affect system ink supply detection and the printing quality.

### SUMMARY OF THE INVENTION

The prime object of the present invention is to provide an external ink supply and balancing system for inkjet printer, in which a proper stopper is installed in each ink container to seal the passage between each ink container and respective vent chamber in the inkjet printer, and each ink container is processed to provide a hole for the mounting of a connector so that one respective flexible ink supply tube can be attached to each ink container to connect one respective external ink bottle to each ink container. When the ink in one ink container dropped below a predetermined low level, a demand signal is produced, and the pump of the inkjet printer is started to pump air out of the ink chamber through an air passageway of the respective ink container to the corresponding external ink bottle, and then the pump is controlled to pump the ink out of the respective ink bottle through the respective ink container into the ink chamber. This procedure is repeated two or three times till that the respective ink chamber of the printing-fluid delivery system has been fully filled with the respective ink.

Another object of the present invention is to provide an external ink supply and balancing system for inkjet printer, in which the ink containers that are inserted into the holder of the inkjet printer are the originally attached ink container of the inkjet printer. This invention simply has the passage between each ink container and the respective vent chamber in the inkjet printer be sealed. Each time the ink supply flow is started, the ink in the ink container is pumped into the respective ink chamber in the printing-fluid delivery system. This ink supply flow fits the original settings of the inkjet printer, allowing air be effectively exhausted out of the ink chamber when supplying a corresponding amount of the respective ink into the respective ink chamber in the printing-fluid delivery system.

Still another object of the present invention is to provide an external ink supply and balancing system for inkjet printer, each time the ink supply flow is started, the exhaust air is guided out of the ink chamber and the respective ink container to the respective external ink bottle through one respective flexible tube, and then the ink is guided from the respective ink bottle to the respective ink container, and therefore each ink container is supplied with the respective ink when the ink level is low.

A further object of the present invention is to provide an external ink supply and balancing system for inkjet printer, in which each time the ink supply flow is started, the exhaust air is guided out of the ink chamber and the respective ink container to the respective external ink bottle through one respective flexible tube, and then exhaust air is guided through a top air discharge connector at the respective external ink bottle to an external buffering air bag via a flexible tube. Therefore, exhaust air is kept in the external air bag and will not be exhausted into the atmosphere.

A still further object of the present invention is to provide an external ink supply and balancing system for inkjet printer, in which each external ink bottle is attached with a top air discharge connector that is connected to an external air bag through a respective flexible tube. The exhaust air that is drawn out of the ink chamber and the respective ink container during an ink supply flow is guided through the respective external ink bottle toward the external air bag and then cumulated in the external air bag. Because the ink in each ink bottle is kept in an enclosed space and isolated from the atmosphere, the chemical composition of the ink will not deteriorate.

Yet another object of the present invention is to provide an external ink supply and balancing system for inkjet printer, in which each ink container in the holder of the inkjet printer has a hole at one side and a connector fastened to the hole for the connection of one respective flexible ink supply tube that is connected to one respective external ink bottle. Each external ink bottle has an ink bottle connector provided to the top for the connection of one respective flexible ink supply tube from the corresponding ink container, and a tube suspending on the inside. During an ink supply flow, the exhaust air is exchanged with the ink.

Another object of the present invention is to provide an external ink supply and balancing system for inkjet printer, in which each external ink bottle is mounted with an ink bottle connector for the connection of one respective flexible ink supply tube from the corresponding ink container and a top air discharge connector that is connected to the external air bag through one respective flexible tube. When the external air bag reaches the saturated status, one top air discharge connector can be detached from the respective ink bottle, and then the air bag can be flattened to empty cumulated air.

Another object of the present invention is to provide an external ink supply and balancing system for inkjet printer, in which the flexible tubes extend from the top air discharge connectors at the ink bottles are connected to the external air bag by an air bag connector. The air bag connector has a flat rear coupling tube that receives the flexible tubes being extended from the top air discharge connectors, a circular front coupling tube that is fastened to the spout tube of the external air bag, and a passage in communication between the flat rear coupling tube and the circular front coupling tube. When the external air bag reaches the saturated status, the air bag connector can be detached from the air bag, and then the air bag can be flattened to empty cumulated air.

Another object of the present invention is to provide an external ink supply and balancing system for inkjet printer, in which each ink bottle has a hole for the connection of the respective top air discharge connector in an airtight manner, and the flexible tubes that are connected between the top air discharge connectors at the ink bottles and the external air bag are arranged into a combine tube that has one end mounted with an air bag connector for connection to the spout tube of the external air bag.

### BRIEF DESCRIPTION OF THE DRAWINGS

FIG. 1 is a perspective view of a conventional inkjet printer.

FIG. 2 is a schematic drawing showing the Active Air Management of the inkjet printer.

FIG. 3 is an ink circulation flow chart, showing inks guided into the ink chamber of the printing-fluid delivery system.

FIG. 4 is an ink circulation flow chart, showing air exhaust out of the ink chamber of the printing-fluid delivery system.

FIG. 5 is an ink circulation flow chart, showing inks flowed back from the vent chambers.

FIG. 6 is a perspective view of the present invention, showing an external ink supply and balancing system installed in an inkjet printer.

FIG. 7 is a plain view of the present invention, showing the external ink supply and balancing system of the ink printer.

FIG. 8 is a perspective view of the present invention, showing the arrangement of the flexible ink supply tubes of the external ink supply and balancing system.

FIG. 9 is an exploded view of a part of the present invention, showing the flexible ink supply tube with the respective L-shaped connector disconnected from the ink container.

FIG. 10 is a perspective view of the present invention, showing the flexible ink supply tube with the respective L-shaped connector connected to the ink container.

FIG. 11 is a sectional view of the present invention, showing the relationship between the ink container and the holder.

FIG. 12 is a sectional view of a part of the present invention, showing a hard stopper sealed to the upper plug hole of the ink container.

FIG. 13 is a sectional view of a part of the present invention, showing a soft stopper sealed to the upper plug hole of the ink container.

FIG. 14 is a sectional view of a part of the present invention, showing a rubber plug fastened to the upper plug hole of the ink container.

FIG. 15 is an exploded view of the present invention, showing one ink bottle of the external ink supply and balancing system.

FIG. 16 is an assembly view of the present invention, showing one ink bottle of the external ink supply and balancing system.

FIG. 17 is a sectional side view of the present invention, showing one ink bottle of the external ink supply and balancing system.

FIG. 18 is an enlarged view of the upper part of FIG. 17.

FIG. 19 is a perspective view of the present invention, showing a part of the external ink supply and balancing system.

FIG. 20 is an exploded view of a part of the present invention, showing the connector of the flexible tubes of the ink balancing unit of the external ink supply and balancing system disconnected from the spout tube of the air bag.

FIG. 21 is a sectional view in an enlarged of a part of the present invention, showing the connector of the flexible tubes of the ink balancing unit of the external ink supply and balancing system disconnected from the spout tube of the air bag.

FIG. 22 is a perspective view of the present invention, showing an alternate form of ink bottles used in the external ink supply and balancing system.

FIG. 23 is a sectional view in an enlarged of a part of the present invention, showing an alternate form of ink bottles used in the external ink supply and balancing system.

### DETAILED DESCRIPTION OF THE PREFERRED EMBODIMENT

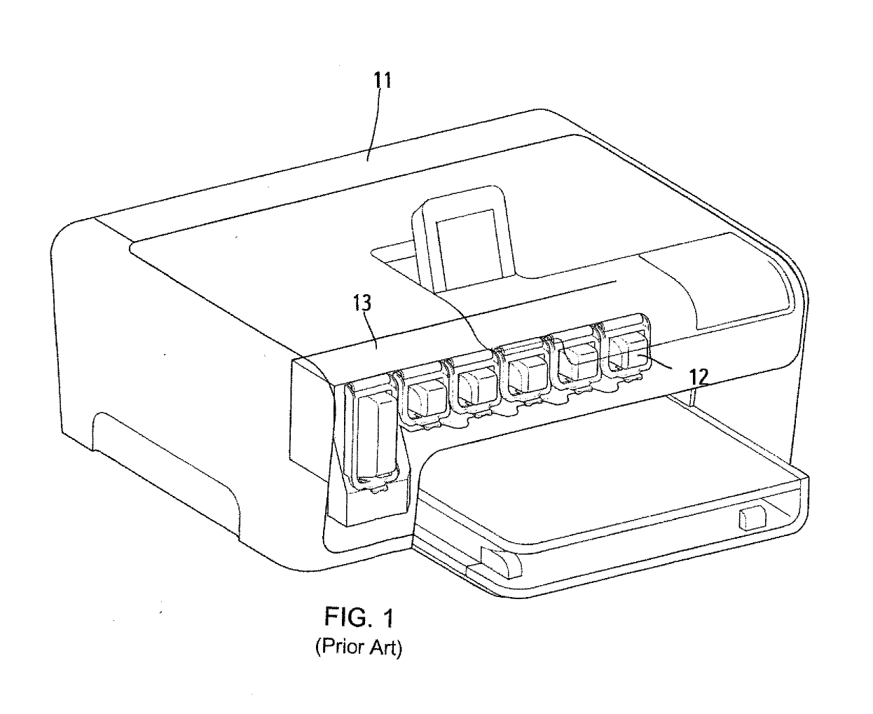

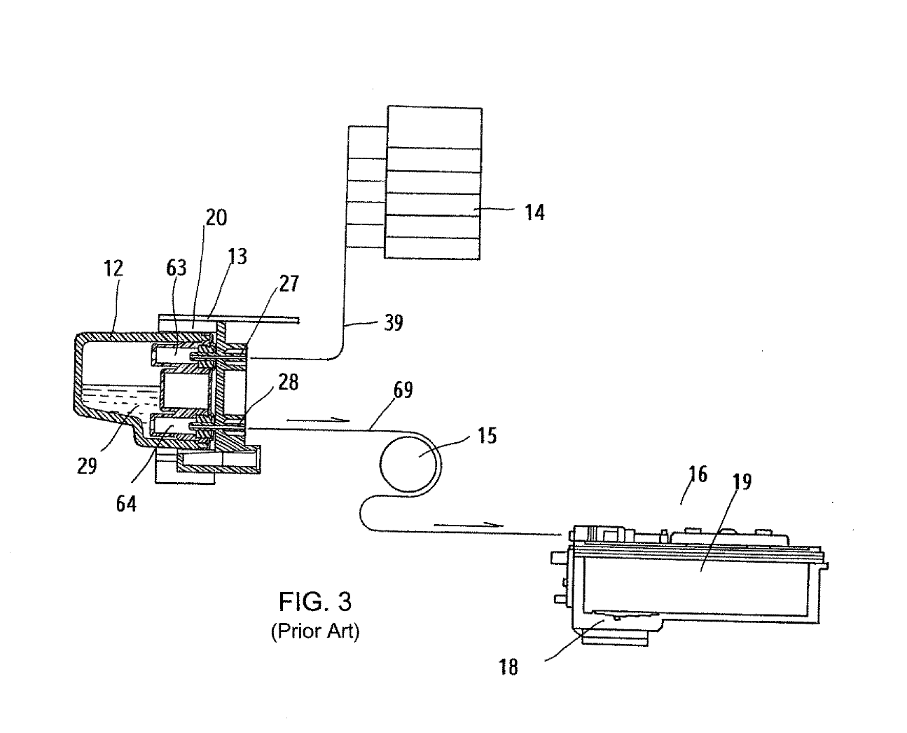

Referring to FIGS. 1 to 5, an ink supply system is shown installed in a conventional inkjet printer 11. The inkjet printer 11 has a holder 13 at the front side. The holder 13 has a number of an ink-container bays 20 adapted for receiving a respective ink container 12, and two plug pipes 27 and 28 suspending in each ink-container bay 20 at different elevations. After insertion of one ink container 12 into one ink-container bay 20, the plug pipes 27 and 28 have the respective front ends inserted into the ink container 12 and kept in air communication with the inside of the ink container 12. The upper plug pipe 27 in each ink-container bay 20 has its rear end connected with a respective flexible tube 39. The flexible tubes 39 are arranged in parallel and respectively extended from the respective upper plug pipes 27 in the ink-container bay 20 to a respective vent chamber 14. The lower plug pipe 28 is each ink-container bay 20 has its rear end connected with a respective flexible tube 69. The flexible tubes 69 are arranged in parallel and respectively extended from the respective lower plug pipes 28 in the ink-container bays 20 to a respective ink chamber 19 in the printing-fluid delivery system 16. A reversible pump 15 is set between the ink chamber 19 and the plug pipes 28 in the ink-container bays 20, and controllable to pump ink from the ink containers 12 to the ink chambers 19 in the printing-fluid delivery system 16 or to pump air out of the ink chambers 19 into the ink containers 12 and then the vent chambers 14.

Please referring to FIGS. 1 to 3, when the inkjet printer 11 is started at its first use, the system initializes a first in circulation. During this first ink circulation, the reversible pump 15 is controlled to pump inks 29 from the ink containers 12 to the ink chamber 19 of the printing-fluid delivery system 16 and to pump air out of the ink chambers 19 and accumulation chambers 18 of the printing-fluid delivery system 16 into the ink containers 12 and then the vent chambers 14. The ink circulation is repeated again and again until the ink chambers 19 and accumulation chambers 18 of the printing-fluid delivery system 16 have been fully filled up with the respective inks. During the first ink circulation process, two circulation flows are employed. These two circular flows will be explained further.

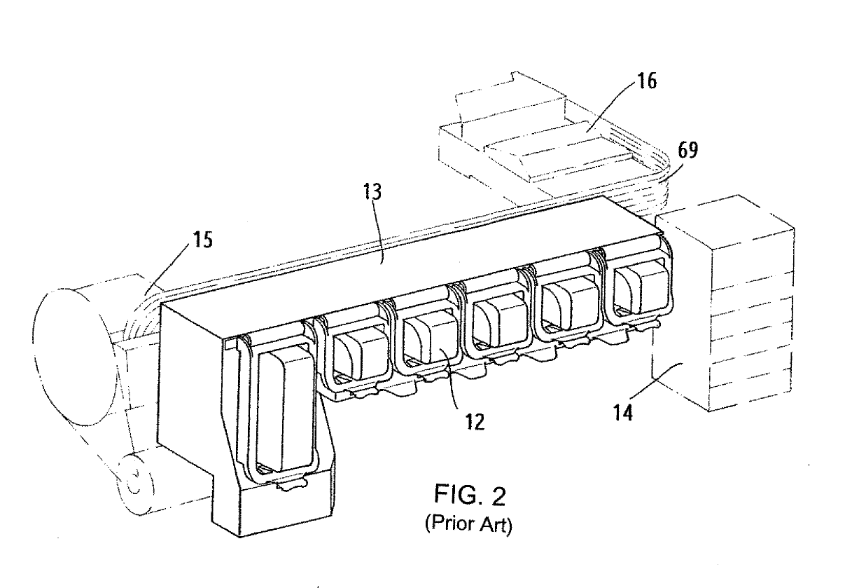

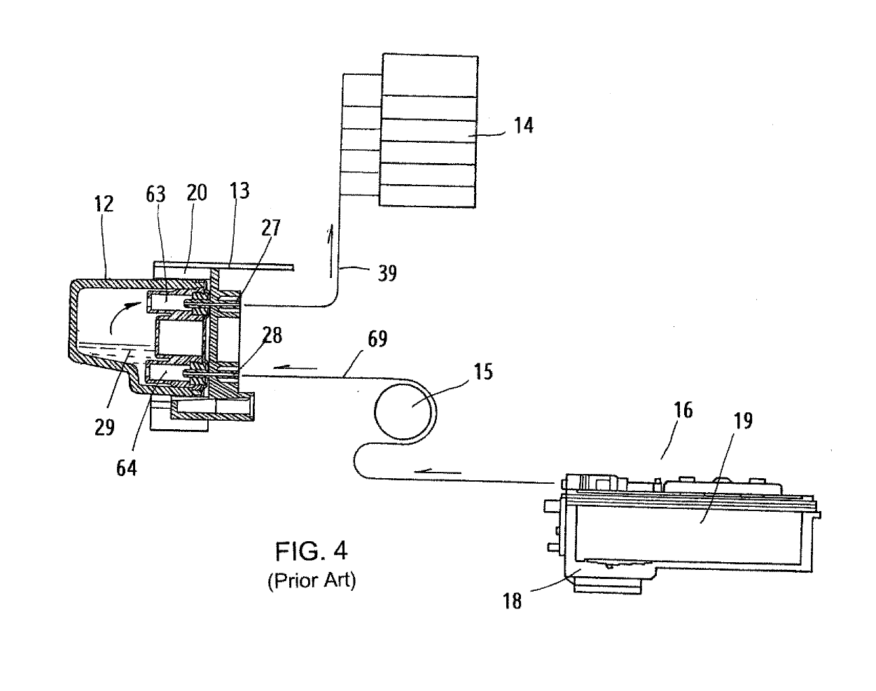

Referring to FIGS. 2 and 4, when the inks in the ink chambers 19 of the printing-fluid delivery system 16 are reducing following the printing service of the inkjet printer 11, a corresponding amount of air enters the ink chambers 19 to substitute for the amount of inks consumed and to balance the pressure in the ink chambers 19. When the ink in one ink chamber 19 dropped below a predetermined low level, a demand signal is produced, causing the reversible pump 15 to start the ink supply flow, so that the reversible pump 15 pumps the ink 29 from the respective ink container 12 to the respective ink chamber 19 in the printing-fluid delivery system 16 and pumps air out of the respective ink chamber 19 into the respective ink container 12. After two or three circulations have been done, the respective ink chamber 19 is fully filled up with the respective ink 19 for printing. During every circulation flow, the ink 29 is guided from the respective ink container 12 toward the printing-fluid delivery system 16, and then air is exhausted out of the ink chamber 19. When the reversible pump 15 pumps air out of the ink chamber 19 through one ink container 12 to the corresponding vent chamber 14, air bubbles are produced in the ink 29 in the respective ink container 12. Following release of air pressure, the air bubbles in the ink 29 move to the corresponding pressure-buffering vent chamber 14.

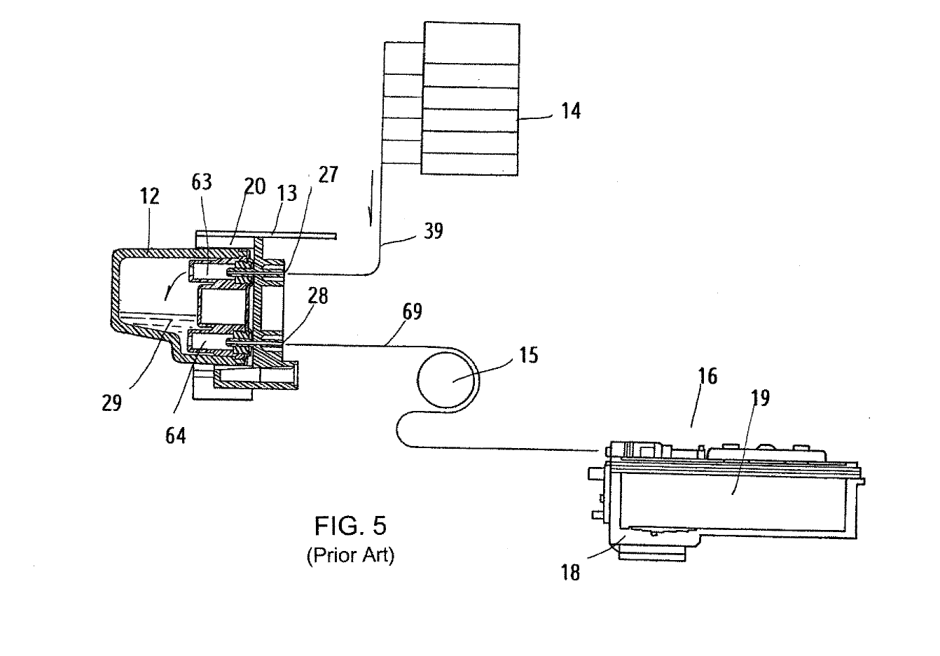

Please referring to FIGS. 2 and 5, during every circulation flow, a certain amount of the ink 29 is carried by the pressurized air into the corresponding vent chamber 14 in the form of ink bubbles. After the end of the circulation flow, ink bubbles contract gradually and finally pop and convert into water-like ink, and residual ink will be guided back to the respective ink container 12 in a next circular flow for use.

Please referring to FIGS. 2 and 6 to 8, when an ink supply and balancing unit of the present invention is used in the aforesaid inkjet printer 11, the passages between the respective ink containers 12 in the holder 13 and the respective vent chambers 14 are blocked, and then each ink container 12 is drilled to provide a round hole for the mounting of a respective L-shaped connector 61. Flexible ink supply tubes 48 having different lengths are arranged into a combine tube and respectively extended from the L-shaped connectors 61 at the ink containers 12 along the plane of the holder 13 out of the inkjet printer 11 to respective plug pipes 44 at respective ink bottle connectors 40 of ink bottles 31. The ink bottles 31 are arranged in parallel and abutted one against another at one lateral side of the inkjet printer 11, so that inks 32 can be guided out of the ink bottles 31 to the ink chamber 19 of the printing-fluid delivery system 16, and exhaust air can be guided out of the ink bottles 31 through respective top air discharge connectors 50 to an air bag 58.

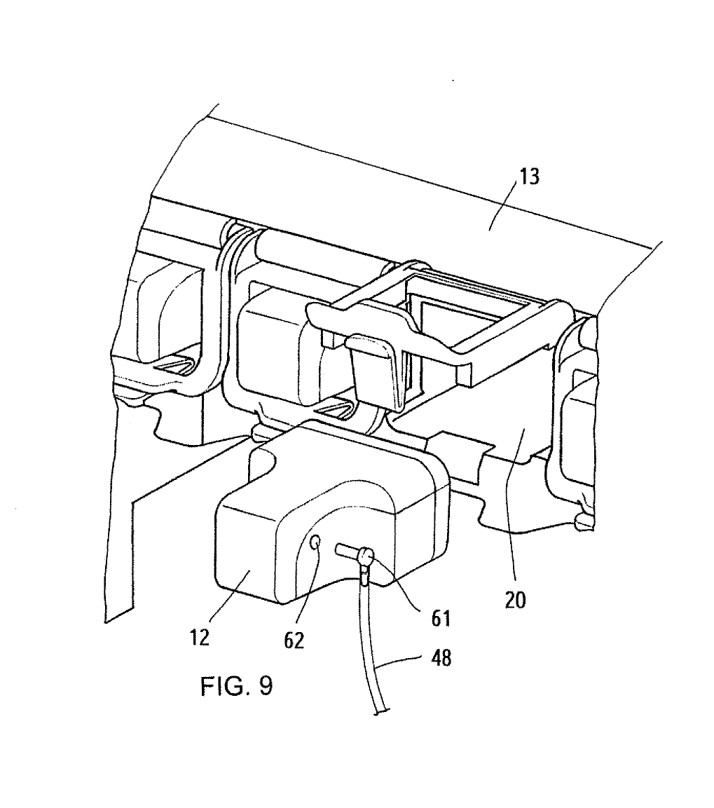

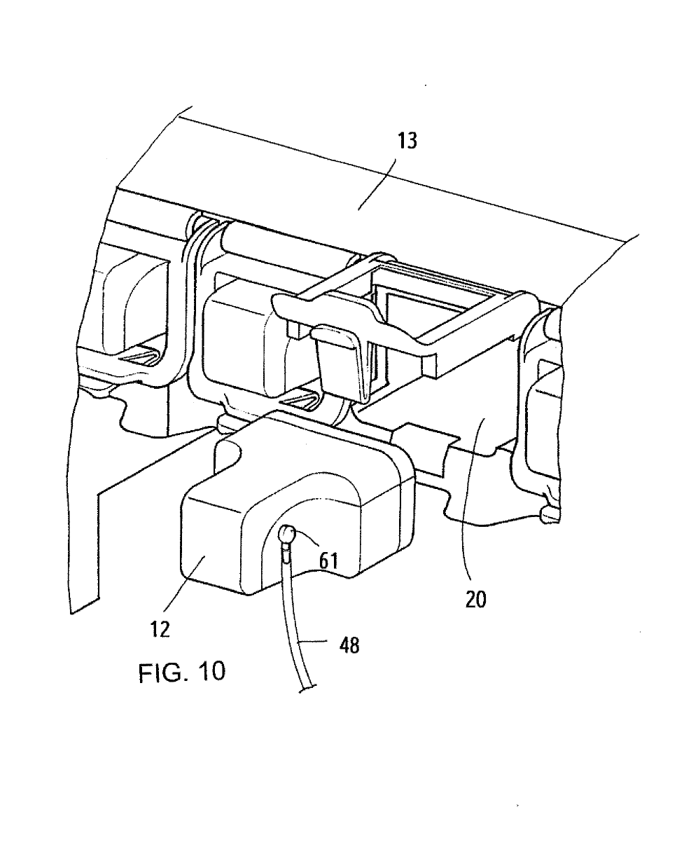

Please referring to FIGS. 2, and 8 to 10, every ink container 12 in the holder 13 of the inkjet printer 11 has a round hole 62 for the mounting of one end of the respective L-shaped connector 61, which has its other end connected to the respective flexible ink supply tube 48. After insertion of ink containers 12 into the holder 13, the flexible ink supply tubes 48 are respectively extended from the L-shaped connectors 61 and then arranged in the form of a combine tube 49 at a suitable location and closely attached to the surface of the holder 13, allowing the other ends of the flexible ink supply tubes 48 to be respectively connected to the ink bottles 31 at one lateral side of the inkjet printer 11.

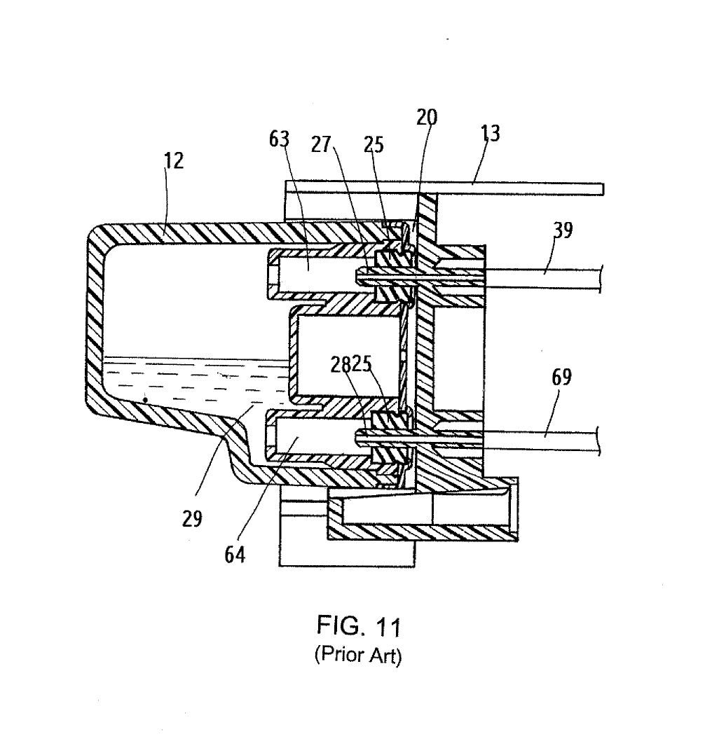

When one ink container 12 is inserted into one respective ink-container bay 20 in the holder 13 of the inkjet printer 11, as shown in FIGS. 2 and 11, two plug holes 63 and 64 of the inserted ink container 12 are respectively forced into engagement with the plug pipes 27 and 28 in the respective ink-container bay 20. The plug holes 63 and 64 of the inserted ink container 12 have a respective sealing member 25 mounted therein. When the plug pipes 27 and 28 are respectively inserted into the plug holes 63 and 64 of the inserted ink container 12, the sealing members 25 seal the gap, preventing ink leakage.

When the ink containers 12 in the inkjet printer 11 are connected to an external ink supply system, the passages between the upper plug pipes 27 in the ink-container bays 20 of the holder 13 and the respective upper plug holes 63 of the ink containers 12 must be blocked, preventing interference with the ink supply operation of the external ink supply system.

Please referring to FIGS. 2, 8 and 12, the interference prevention is done by: first, blocking the upper plug hole 63 of each ink container 12 to isolate the ink into the vent chamber 14; second, a round hole 62 is made in one side of each ink container 12 for the mounting of one end of the respective L-shaped connector 61, which has its other end connected to the respective flexible ink supply tube 48. By means of this arrangement, exhaust air is prohibited from entering the corresponding vent chamber 14 but guided out of the ink container 12 through the associating L-shaped connector 61 and the associating flexible ink supply tube 48.

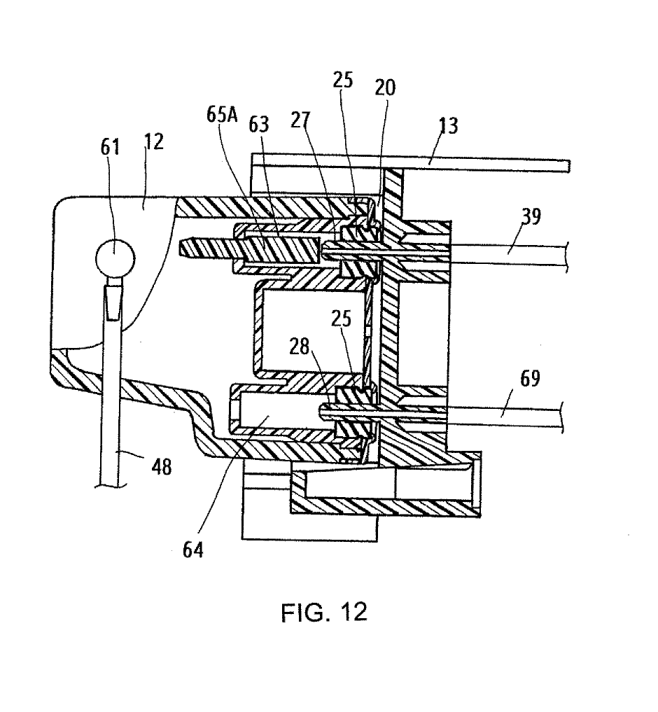

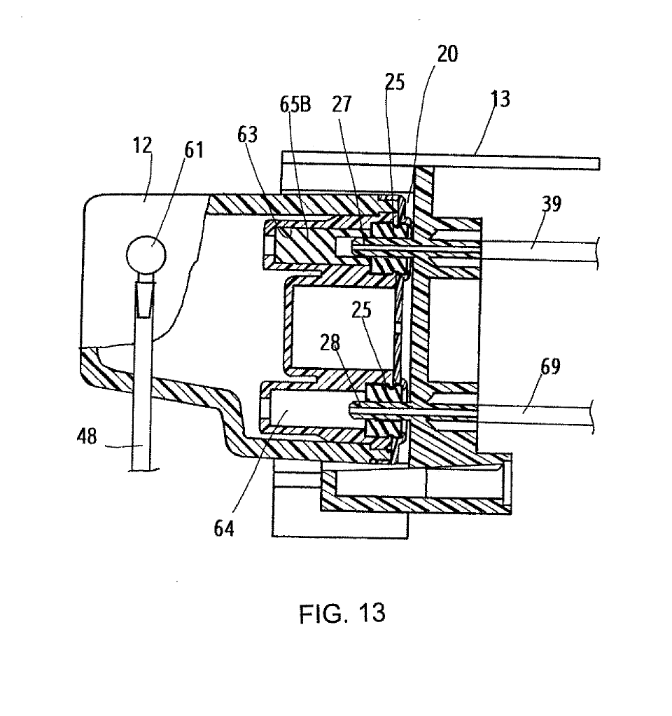

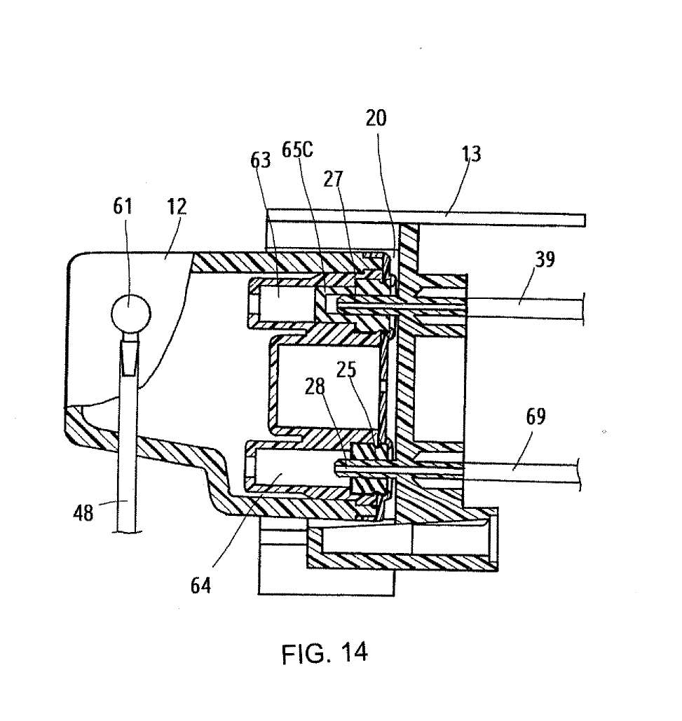

Please referring to FIG. 12, a stopper 65 is fastened to the upper plug hole 63 of the ink container 12 to seal the passage between the ink container 12 and the corresponding upper plug pipe 27. The stopper 65 can be made of any material in any shape. For example, a silicon rubber material is filled in the upper plug hole 63 and hardened to form the stopper 65 that seals the plug hole 63. Alternatively, the stopper 65A can be a hard cylindrical stopper press-fitted into the plug hole 63 (shown FIG. 12), a soft rubber stopper 65B fitted into the plug hole 63 (shown FIG. 13), or a rubber plug stopper 65C used to substitute for the original sealing member 25 (shown FIG. 14). In either of the aforesaid various different alternate forms, the stopper 65 seals the passage of the plug hole 63.

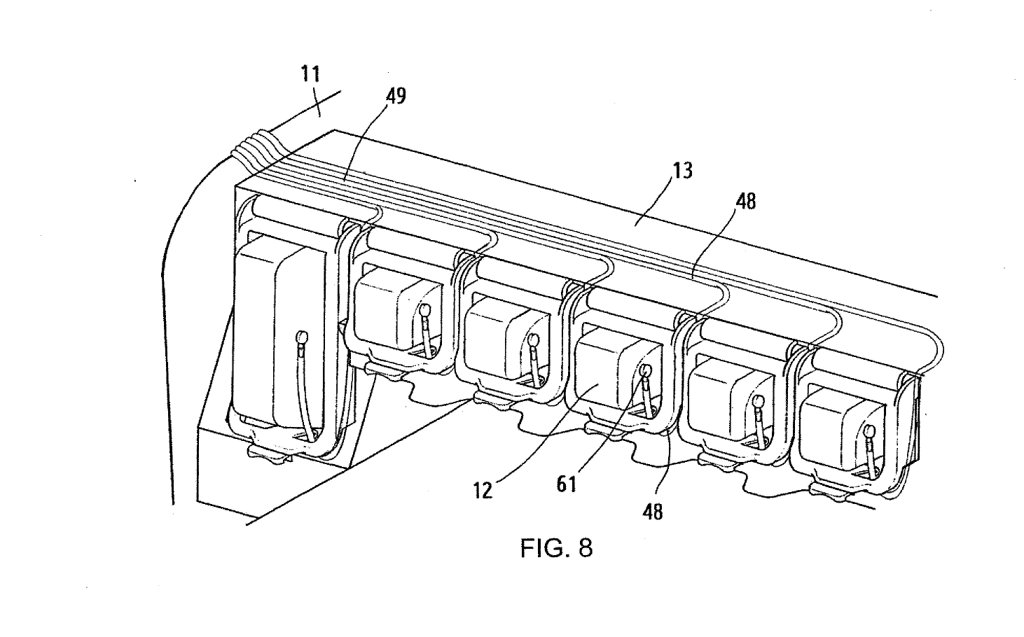

Please referring to FIGS. 8 to 10, each ink container 12 in the holder 13 of the inkjet printer 11 has one round hole 62 and a L-shaped connector 61 fastened to the round hole 62 and connected with one respective flexible ink supply tube 48 so that each ink circulation path of the inkjet printer 11 is extending to the outside of the inkjet printer 11 through the L-shaped connector 61 at the associating ink container 12 and the associating flexible ink supply tube 48.

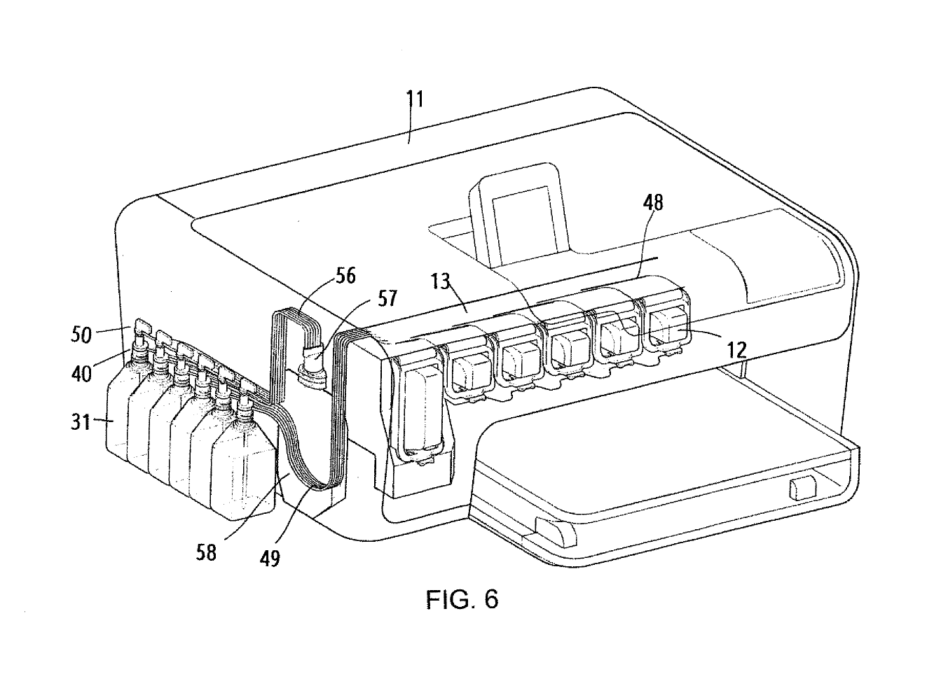

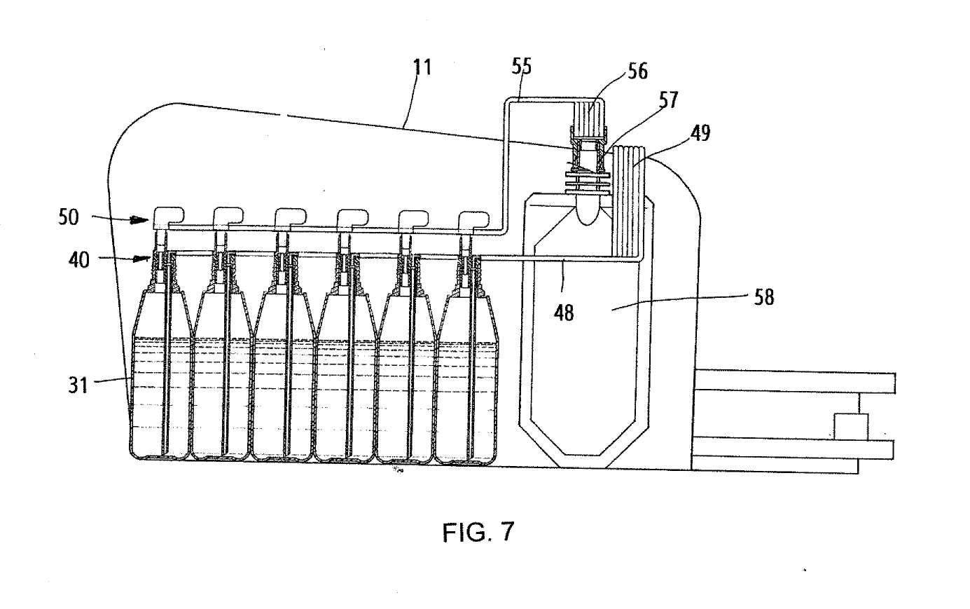

Please referring to FIGS. 6 and 7, the combine tube 49 extends out of the top side of the holder 13 of the inkjet printer 11, and is comprised of multiple flexible ink supply tubes 48 that have different lengths and respectively connected between the ink containers 12 in the holder 13 and the plug pipes 44 of the ink bottle connectors 40 that are respectively fastened to the ink bottles 31 at one lateral side of the inkjet printer 11.

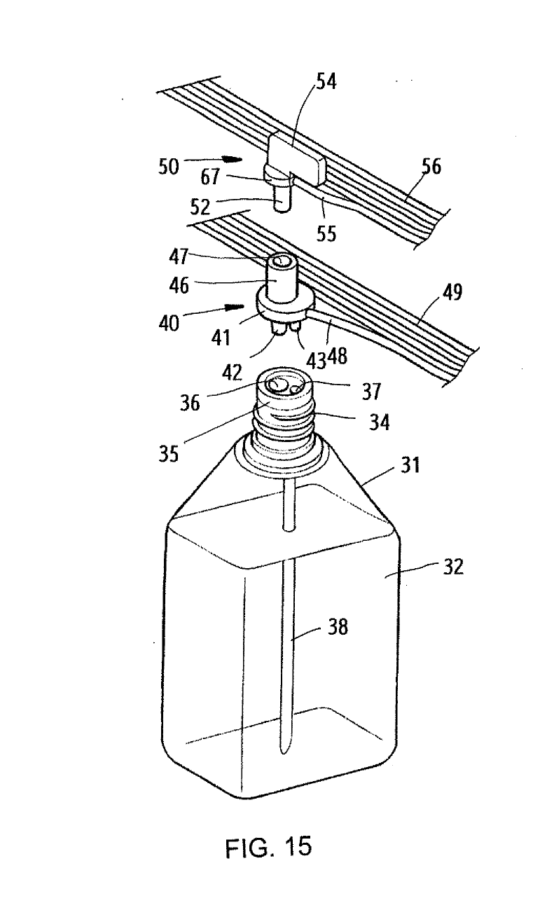

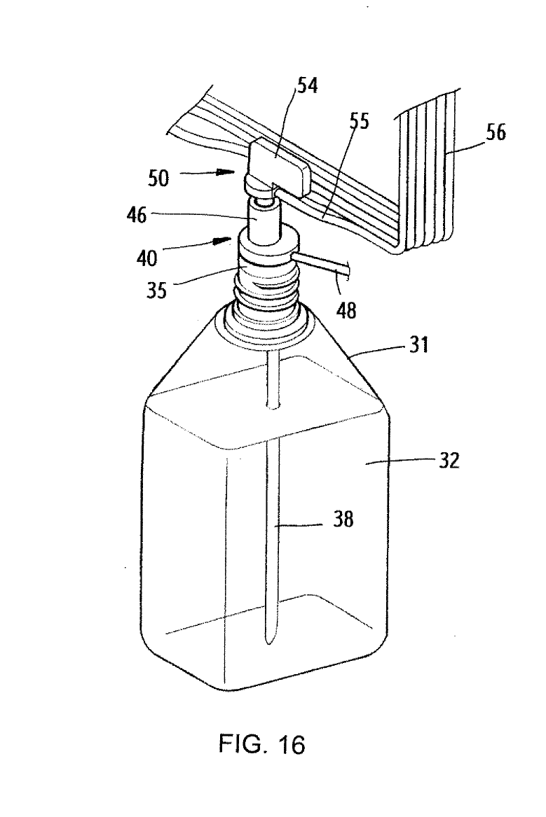

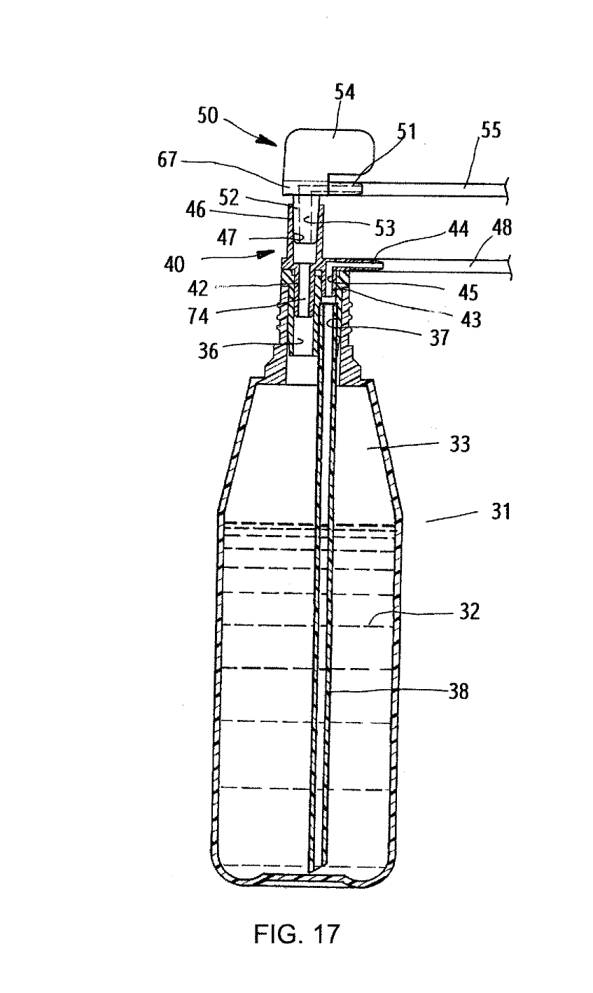

Please referring to FIGS. 15 to 17, each ink bottle 31 has a substantially rectangular container; a bottle plug 35 fastened to the bottle neck 34 thereof, and a tube 38 suspending from the bottle plug 35. The bottle plug 35 has a first cylindrical hole 36 and a second cylindrical hole 37 axially cut through the top and bottom sides. The tube 38 is connected to the second cylindrical hole 37 and extending downwards from the bottle plug 35 in the ink bottle 31 to an elevation in proximity to the bottom wall of the ink bottle 31. The first cylindrical hole 36 has a diameter greater than the second cylindrical hole 37, and is disposed in air communication with the inside space of the ink bottle 31. Further, each ink bottle 31 is filled with an ink 32. The bottle plug 35 of the ink bottle 31 is mounted with one respective ink bottle connector 40, which has a plug pipe 44 disposed in communication with the tube 38 in the ink bottle 31 through a L-shaped passage 45 so that the ink 32 can be guided out of the respective ink bottle 31 through the L-shaped passage 45 to the corresponding ink container 12.

The ink bottle connector 40 that is fastened to the top side of the bottle plug 35 in one ink bottle 31 further comprises a body portion 41 of a predetermine diameter, and a first plug pipe 42 and a second plug pipe 43 at the bottom side of the body portion 41. When fastening the ink bottle connector 40 to the top side of the bottle plug 35, the first plug pipe 42 is plugged into the first cylindrical hole 36, and the second plug pipe 43 is plugged into the second cylindrical hole 37. The plug pipe 44 of the ink bottle connector 40 is suspending in the periphery of the body portion 41 for the connection of the associating flexible ink supply tube 48 that has its other end connected to the corresponding ink container 12, and disposed in communication with the second plug pipe 43 through the L-shaped passage 45.

The body portion 41 has a predetermined thickness. The first plug pipe 42 fits the first cylindrical hole 36 in diameter. When the first plug pipe 42 is press-fitted into the first cylindrical hole 36, it is secured to the bottle plug 35 in a water tight manner. The ink bottle connector 40 further comprises a top receptacle 46 perpendicularly upwardly extending from the top wall of the body portion 41 in axial alignment with the first plug pipe 42, and an inside hole 74 in communication between the axial hole 47 defined in the top receptacle 46 and the first plug pipe 42. Therefore, the axial hole 47 is disposed in air communication with the space 33 inside the ink bottle 31 above the level of the ink 32.

For allowing exhaust of air and prohibiting exhaust air from passing to the atmosphere during each ink circulation process of the inkjet printer, as shown in FIGS. 6 and 7, the ink bottle connector 40 at each ink bottle 31 is provided with one respective top air discharge connector 50. The top air discharge connector 50 is connected with a flexible tube 55. The flexible tubes 55 that are respectively extended from the top air discharge connectors 50 at the ink bottles 31 are arranged together and connected to the aforesaid air bag 58 through a connector 57. Therefore, during each ink circulation operation of the inkjet printer, exhaust air is gathered in the air bag 58. Because the ink 32 in each ink bottle 31 is constantly kept in an airtight environment, the chemical composition of the ink 32 will not deteriorate, i.e., the ink quality is maintained.

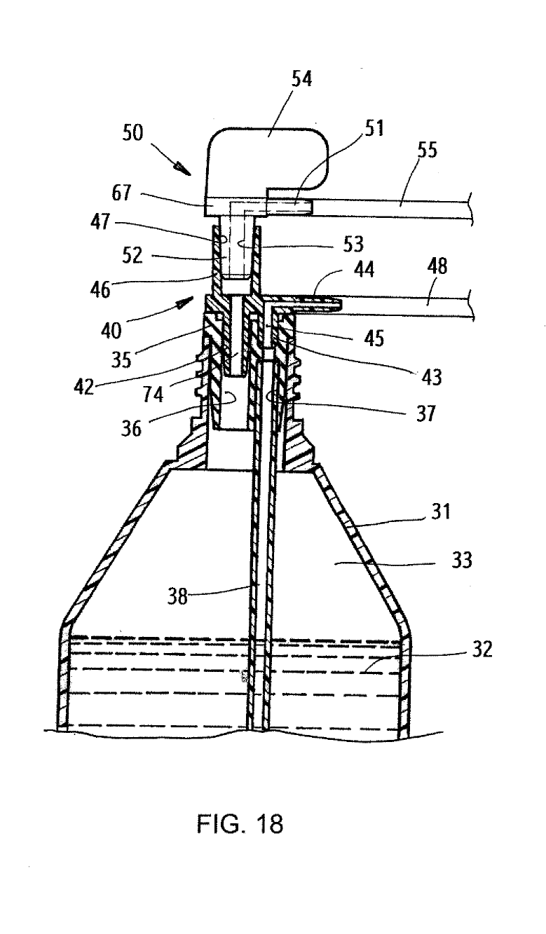

Referring to FIGS. 15 to 18, the top air discharge connector 50 comprises a stop plate 67, a plug pipe 51 disposed at one side of the stop plate 67 for the connection of the respective flexible tube 55, a grip plate 54 at the top side of the stop plate 67 by which a person can mount/dismount the top air discharge connector 50 conveniently, a plug pipe 52 downwardly extending from the stop plate 67 in fluid communication with the plug pipe 51 through a L-shaped passage 53, which is defined in the stop plate 67. The plug pipe 52 is press-fitted into the axial hole 47 of the top receptacle 46 of the corresponding ink bottle connector 40. When installed, as shown in FIG. 6, the flexible tubes 55 that are respectively extended from the top air discharge connectors 50 at the ink bottles 31 are arranged together and connected to the connector 57 at the air bag 58.

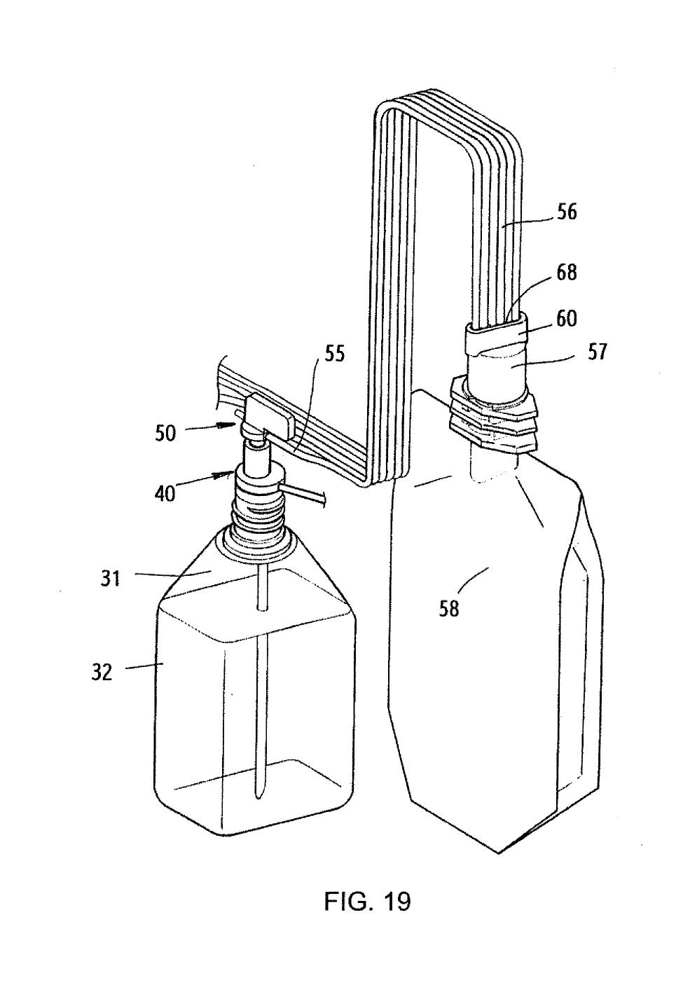

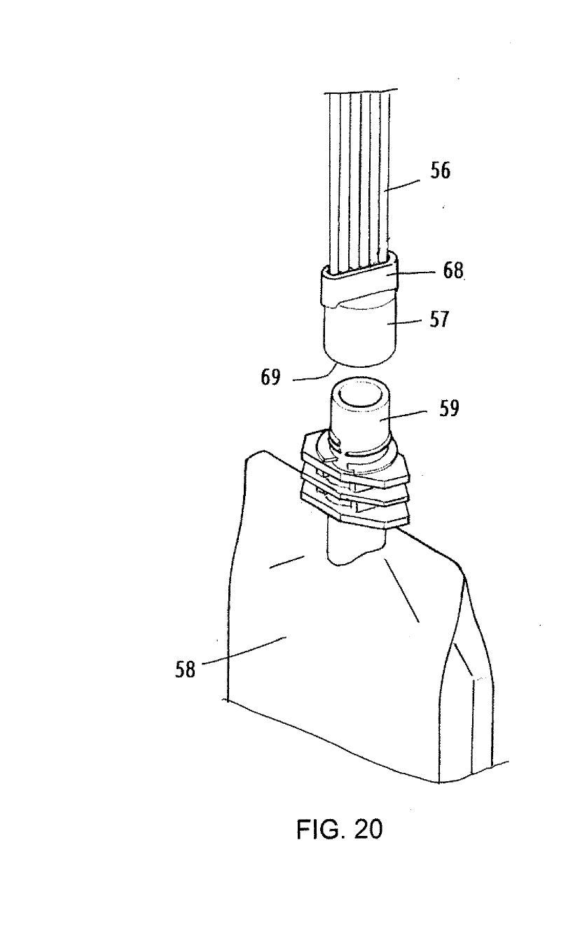

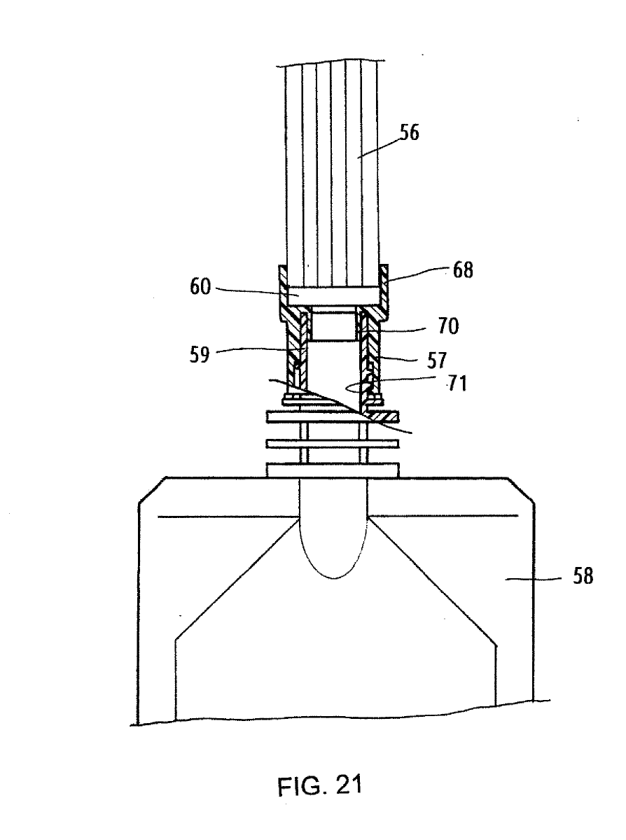

Referring to FIGS. 6, 7, and 19 to 21, the flexible tubes 55 that are respectively connected between the top air discharge connectors 50 at the ink bottles 31 and the connector 57 at the air bag 58 are arranged into a combine tube 56. The connector 57 has a flat rear coupling tube 68 that receives the combine tube 56, a circular front coupling tube 69 that is fastened to a spout tube 59 of the air bag 58, and a passage 60 in communication between the flat rear coupling tube 68 and the circular front coupling tube 69.

After connection of the circular front coupling tube 69 to the spout tube 59 of the air bag 58, an adhesive is applied to the connection area between the circular front coupling tube 69 to the spout tube 59 to fixedly secure the circular front coupling tube 69 and the spout tube 59 together. After installation, the combine tube 56 is connected to the flat rear coupling tube 68, and the circular front coupling tube 69 is connected to the spout tube 59 of the air bag 58, and therefore the combine tube 56 is in air communication with the inside space of the air bag 58 through the passage 60. The connector 57 further comprises an inside retaining ring 70 in the passage 60 and an inside annular flange 71 around the inside wall of the circular front coupling tube 69. When the circular front coupling tube 69 is fastened to the spout tube 59, the inside retaining ring 70 and the inside annular flange 71 give a pressure to the spout tube 59, enhancing the connection tightness between the circular front coupling tube 69 and the spout tube 59.

The air bag 58 is an inflatable bag closely attached to one lateral side of the inkjet printer 11. During each ink circulation operation of the inkjet printer 11, exhaust air go into the ink bottles 31 and then go through the respective top air discharge connectors 50 toward the air bag 58, and therefore exhaust air is collected in the air bag 58.

After a certain number of ink circulation cycles with the use of the inkjet printer 11, the amount of exhaust air collected in the air bag 58 is increased. When accumulated air in the air bag 58 reaches a saturation status, the connector 57 is disconnected from the spout tube 59 of the air bag 58, and then the air bag 58 is flattened to force accumulated air out of the air bag 58. After the air bag 58 is cleared, the spout tube 59 of the air bag 58 is connected to the connector 57 again for collecting exhaust air from the inkjet printer 11.

In general, an external ink supply device is connected to the inkjet printer 11. The external ink supply device comprises a plurality of ink bottles 31. Each ink bottle 31 is mounted with a respective ink bottle connector 40. The ink bottle connectors 40 are respectively connected with a respective flexible ink supply tube 48. The flexible ink supply tubes 48 are respectively connected to the ink containers 12 in the holder 13 of the inkjet printer 11, and arranged together in the form of a combine tube 49. Each ink container 12 has the respective upper plug hole 63 sealed with a stopper 65 to block the original exhaust system, and is mounted with a respective L-shaped connector 61, which is connected to the corresponding ink bottle 31 to provide a passage for exhaust air. Therefore, the ink bottles 31 can provide respective inks to the corresponding ink containers 12 and allow exhaust air to be guided out of the inkjet printer 11.

The ink bottle connectors 40 at the ink bottles 31 are respectively connected to the ink containers 12 in the inkjet printer 11 and respectively mounted with a respective top air discharge connector 50 that is respectively connected to an air bag 58. Therefore, when air is exhausted out of the ink containers 12, it is not discharged into the atmosphere but guided through the top air discharge connectors 50 to the air bag 58.

Normally, the ink 32 in each ink bottle 31 is kept in an airtight environment, and every ink circulation operation of the inkjet printer 11 is performed in an enclosed space, preventing deterioration of the chemical composition of the ink 32 and maintaining the printing quality.

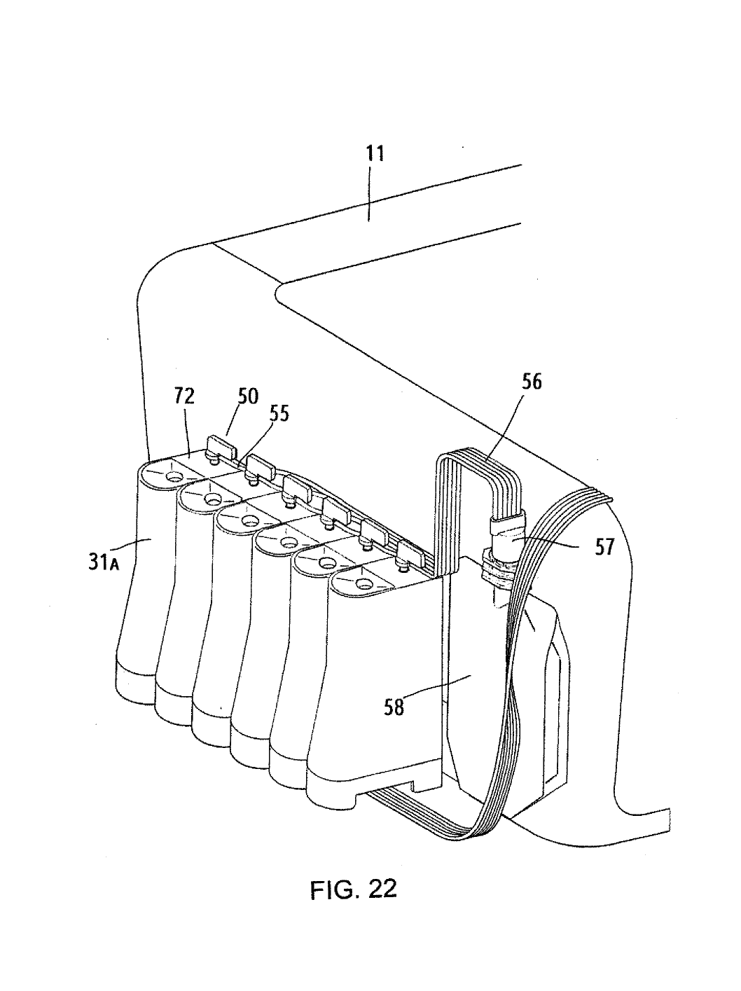

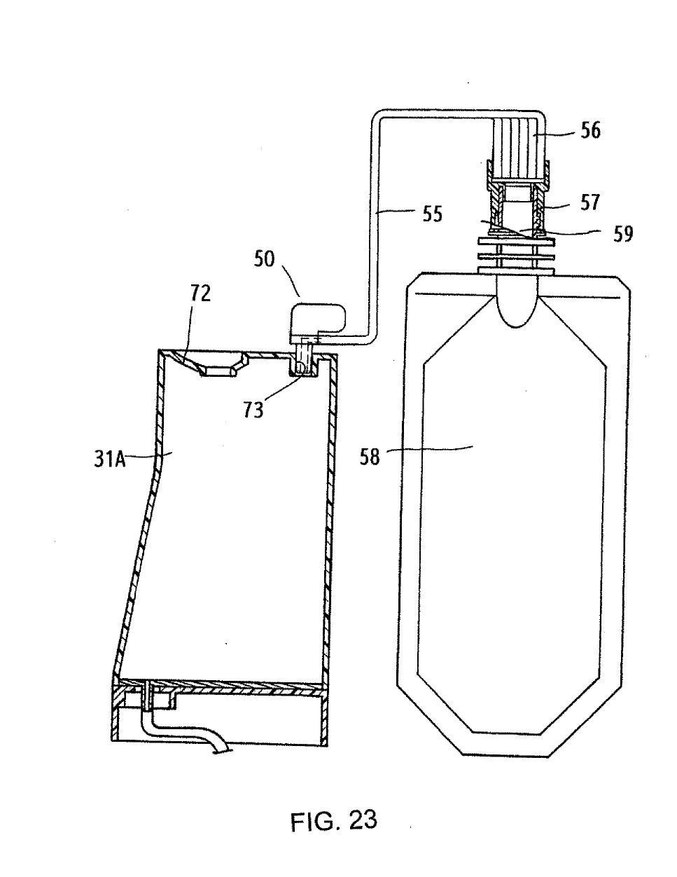

Referring to FIGS. 22 and 23, the ink bottle 31A has a bottle body 72 that has the same configurations as the ink bottle commonly used in conventional external ink supply devices. The bottle body 72 has a top plug hole 73 for the connection of one top air discharge connector 50 that is connected to an air bag 58 through one respective flexible tube 55. The flexible tubes 55 that are connected between the top air discharge connectors 50 at the ink bottles 31A and the air bag 58 are arranged into a combine tube 56. When the inkjet 11 is started to run an ink circulation flow, exhaust air is collected in the air bag 58.

While the invention has been described with reference to specific embodiments it must be understood that those embodiments are susceptible to many changes, substitutions and modifications that will be readily apparent to those having ordinary skill in the art without departing from the scope and spirit of the invention.

What is claimed is:

1. An external ink supply and balancing system for inkjet printer, the external ink supply and balancing system comprising:
an ink supply unit, comprising:
a plurality of ink containers respectively mounted in said inkjet printer, each said ink container comprising an upper plug hole sealed with a stopper, a round hole at one side thereof;
a plurality of L-shaped connectors respectively fastened to the round holes of said ink containers;
a plurality of ink bottles, each said ink bottle holding therein an ink and having an inside space above the level of the ink therein; and
a plurality of flexible ink supply tubes respectively connected between said L-shaped connectors and said ink bottles for enabling the inks in said ink bottle to be respectively supplied to said ink containers; and
an ink balancing unit, comprising:
a plurality of air discharge connectors respectively connected to said ink bottles for guiding air out of said ink bottles, each said air discharge connector comprising a plug pipe connected to one said ink bottle and a plug pipe disposed in air communication with said plug pipe;
an air bag for collecting exhaust air from said ink bottles, said air bag comprising a spout tube for input of exhaust air;
an air bag connector, said air bag connector comprising a flat rear coupling tube, a circular front coupling tube fastened to the spout tube of said air bag and disposed in communication with said flat rear coupling tube; and
a plurality of flexible tubes respectively connected between the plug pipes of said air discharge connectors and said flat rear coupling tube of said air bag connector for guiding exhaust air from said ink bottles to said air bag.

2. An external ink supply and balancing system for inkjet printer as claimed in claim 1, wherein said ink bottle comprises a bottle body having a bottle neck, a bottle plug fastened to said bottle neck, said bottle plug having a cylindrical hole for the connection of one said air discharge connector, and a tube fastened to said bottle plug and suspending in said bottle body and disposed in fluid communication with one said flexible ink supply tube.

3. An external ink supply and balancing system for inkjet printer as claimed in claim 1, wherein said ink bottle comprises a bottom plug pipe disposed at a bottom side thereof and connected to one said L-shaped connector at one said ink container through one said flexible ink supply tube, and a top plug hole connected to one said air discharge connector.

4. An external ink supply and balancing system for inkjet printer, the external ink supply and balancing system comprising:
an ink supply unit, comprising a plurality of ink bottles disposed outside said inkjet printer and respectively connected to respective ink containers in said inkjet printer by a respective flexible ink supply tube; and
an ink balancing unit, comprising:
a plurality of air discharge connectors respectively connected to said ink bottles for guiding air Out of said ink bottles, each said air discharge connector comprising a plug pipe connected to one said ink bottle and a plug pipe disposed in air communication with said plug pipe;
an air bag for collecting exhaust air from said ink bottles, said air bag comprising a spout tube for input of exhaust air;
an air bag connector, said air bag connector comprising a flat rear coupling tube, a circular front coupling tube fastened to the spout tube of said air bag and disposed in communication with said flat rear coupling tube; and
a plurality of flexible tubes respectively connected between the plug pipes of said air discharge connectors and said flat rear coupling tube of said air bag connector for guiding exhaust air from said ink bottles to said air bag.
